(19) United States
(12) Patent Application Publication
(10) Pub. No.: US 2004/0074134 A1
(43) Pub. Date: Apr. 22, 2004

(54) Fishing lure

(76) Inventor: Ronald Roger Morlen I, Granite City, IL (US)

Correspondence Address: Patrick W. Rasche, Armstrong Teasdale LLP, Suite 2600, One Metropolitan Square, St. Louis, MO, 63102, US

(21) Appl. No.: 10/661,981

(22) Filed: Sep. 12, 2003

Related U.S. Application Data
(60) Provisional application No. 60/410,102, filed on Sep. 12, 2002.

(51) Int. Cl. A01K 85/00

(52) U.S. Cl. 43/42.13

(57) ABSTRACT

A hook assembly includes a shank portion, a curved portion extending from the shank portion, and a loop extending from the curved portion.

### CROSS REFERENCE TO RELATED APPLICATIONS

This application claims the benefit of U.S. Provisional Application No. 60/410,102, filed Sep. 12, 2002, which is hereby incorporated by reference in its entirety.

### BACKGROUND OF THE INVENTION

This invention relates generally to fishing equipment and more particularly, to a fishing lure.

Many different baits are available for angler fishermen, including a variety of artificial lures. At least some known artificial lures include flexible fish-shaped bodies to which fishing paraphernalia, including hooks, spinner blades and weights may be attached. More specifically, at least one known fishing lure system includes a single hook inserted into the mouth of the lure and extended outwardly through the back of the lure. Weights and other enhancements, such as spinner blades, are attached to the fishing line before the line is tied to the hook near the lure mouth.

One embodiment of a known spinner lure includes a body comprising a single length of wire having a bend generally in the middle thereof. On one end of the wire is attached a hook and lead weight and on the other end of the wire a spinner blade is attached thereto by means of a swivel. The spinner lure is attached to the fishing line at approximately the position of the bend in the wire. Drawing the lure through the water by conventional fishing tackle causes the lure to spin thereby attracting fish.

The ability to alternate and experiment with various spinner blades is an important aspect of successfully luring a fish to the hook. However, spinner blades are separately attached and spaced from the hook and thereby fail to attract attention to the bait on the hook. Additionally, the alignment of the weights and enhancements with respect to the lure body, and/or the relative position of the hook with respect to the lure body, may cause the lure to twist when being retrieved with a reel when fishing. Twisting the lure presents an unnatural presentation of the lure, and depending on the severity of the twist, the line may become knotted in the reel. Furthermore, changing the spinner blades after the fishing lure has been rigged may also be a time-consuming task.

### BRIEF SUMMARY OF THE INVENTION

In one aspect, a hook assembly is provided. The hook assembly includes a shank portion, a curved portion extending from the shank portion, and a loop extending from the curved portion.

In another aspect, a fishing lure system is provided. The fishing lure system includes a wire assembly and a hook assembly coupled to the wire assembly. The hook assembly includes a shank portion, a curved portion extending from the shank portion, a tail portion extending from the curved portion, and a loop extending from the curved portion.

In a further aspect of the invention, a hook having an attachment end coupled to a body is provided. The hook includes a shank portion substantially parallel to an axis, a curved portion having a first end extending from the shank portion and curving away from the axis, the curved portion having a second end, a tail portion extending from the second end of the curved portion, and a loop extending from the curved portion.

### BRIEF DESCRIPTION OF THE DRAWINGS

FIG. 1 is a perspective view of one embodiment of a fishing lure system.

FIG. 2 is a perspective view of a hook assembly of the fishing lure system of FIG. 1.

### DETAILED DESCRIPTION OF THE INVENTION

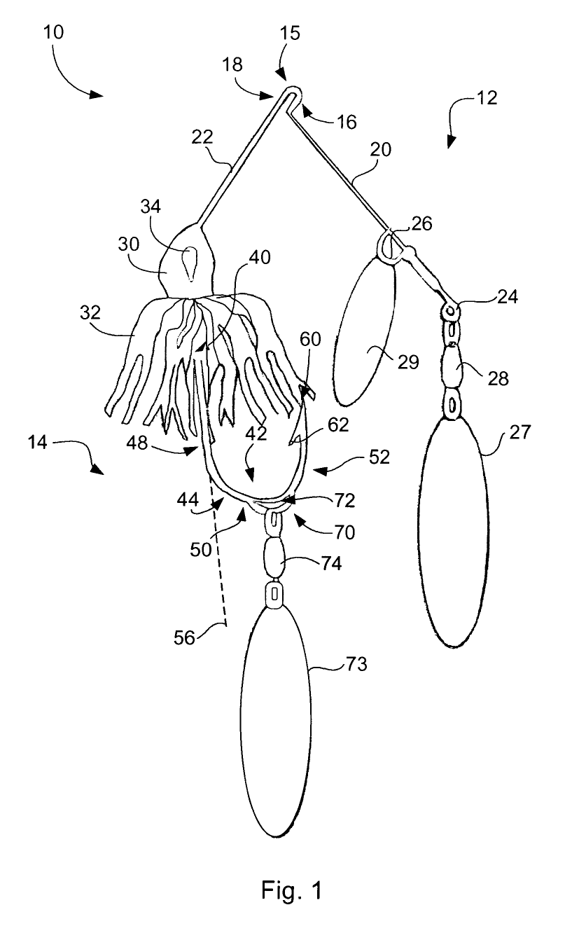

FIG. 1 is a perspective view of one embodiment of a fishing lure system 10. Fishing lure system 10 is exemplary only and is not limited to the lure shown. Other lures may be utilized to practice the invention described herein.

Fishing lure system 10 includes a lead 12 and a hook assembly 14. Lead 12 includes a bend 15 having a first end 16 and a second end 18. A first wire portion 20 extends from first end 16 and a second wire portion 22 extends from second end 18 in an opposite direction. In one embodiment, first and second wire portions 20 and 22 are spaced substantially 90° degrees apart from one another. Fishing lure system 10 is coupled to fishing line (not shown) at bend 15, or alternatively, fishing lure system 10 is coupled to fishing line via a swivel (not shown) at bend 15.

First wire portion 20 has a first eyelet 24 at a distal end thereof. In one embodiment, first wire portion 20 has a second eyelet 26 spaced apart from first eyelet 24. In another embodiment, first wire portion 20 has a plurality of eyelets along a length of first wire portion 20. A first spinner blade 27 is coupled to first eyelet 24 via a barrel swivel or spinner extension 28. A second spinner blade 29 is coupled directly to second eyelet 26.

Second wire portion 22 has a body 30 at one end. A skirt 32 of fibrous material extends from body 30 and is bound to body 30 by, for example, a resilient ring (not shown). In one embodiment, skirt 32 could also be bound to body 30 with wire or string. Body 30 is covered with a paint coating which includes a simulated eye 34 to enhance the attraction of fish to fishing lure system 10.

Hook assembly 14 includes an attachment end 40 fixedly connected to body 30. Hook assembly 14 has an inner edge 42 facing inwardly and an outer trailing edge 44 facing outwardly. Hook assembly 14 has a shank portion 48, a curved portion 50, and a tail portion 52. Shank portion 48 extends substantially parallel to an axis 56. Curved portion 50 has a first end extending from shank portion 48 and curves away from axis 56. Curved portion 50 has a second end with tail portion 52 extending therefrom. Tail portion 52 is substantially straight and terminates at a point 60. A barb 62 extends from distal end of tail portion 52 and in an opposite direction of point 60. Hook assembly includes a loop 70 extending from outer trailing edge 44 of curved portion 50 forming a loop opening 72.

A spinner blade 73 is coupled to loop 70 via a spinner extension 74. Spinner blade 73 gives a larger appearance for hook assembly 14 and creates more visibility and vibrations to attract fish. Loop 70 also allows for a user to interchange a variety of fishing paraphernalia. Loop 70 and spinner blade 73 do not compromise the functionality of fishing lure system 10. For example, the addition of a trailer hook (not shown) is possible because loop opening 72 is large enough to accommodate any necessary retention device of the trailer hook. In addition, the location of loop 70 on curved portion 50 maintains the balance of hook assembly 14 when fishing paraphernalia is coupled thereto.

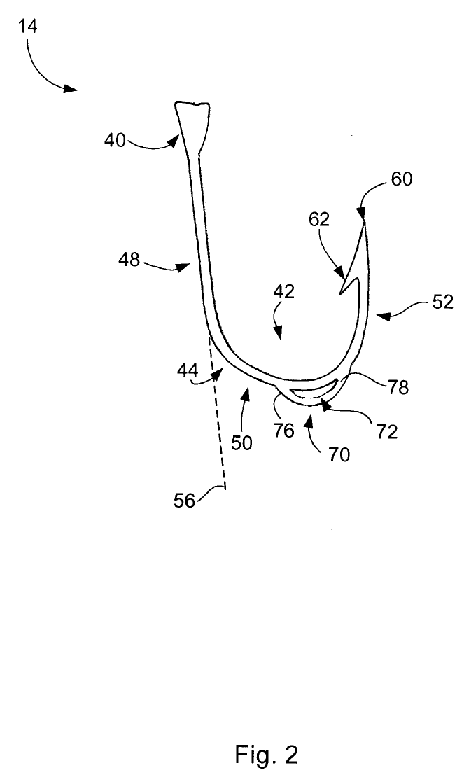

FIG. 2 is an exemplary embodiment of hook assembly 14. In one embodiment, loop 70 extends from either shank portion 48 or tail portion 52. Loop 70 extends from outer trailing edge 44 of curved portion 50. Loop 70 is centrally located along outer trailing edge 44 of curved portion 50. In one embodiment, loop 70 extends from curved portion 50 along outer trailing edge 44 in a plurality of locations between tail portion 52 and shank portion 48. In another embodiment, loop 70 extends from inner edge 42 of curved portion 50. Loop 70 is generally planar with hook assembly 14. In one embodiment, loop 70 extends from outer trailing edge 44 in a generally non-planar direction.

Loop 70 is arcuate having a first end 76 and a second end 78 formed integral to curved portion 50. In one embodiment, loop 70 is welded, soldered or braised to curved portion 50. In another embodiment, at least one of first and second ends 76 and 78 is coupled or formed integral to curved portion 50 and the other of first and second ends 76 and 78 is spaced from curved portion 50 for attachment of fishing paraphernalia to loop 70. Loop 70 is fabricated from substantially the same material as curved portion 50. In one embodiment, loop 70 is fabricated from a different material from curved portion 50. In another embodiment, loop 70 is fabricated from either metal, plastic, rubber, or string. In another embodiment, loop 70 is formed in a plurality of shapes, such as a square shape or a triangular shape.

Loop 70 allows a user to couple a variety of fishing paraphernalia including, but not limited to, hooks, weights, spinner blades, and trailer hooks. Spinner blade 73 coupled to hook assembly 14 increases the ability of the fishing lure system 10 to attract fish both through visual and vibratory cues, and also serves to camouflage hook assembly. Moreover, loop 70 allows various types of spinners to be added to fishing lure system 10 quickly and safely. Thus, the natural appearance of fishing lure system 10 remains substantially unmarred.

While the invention has been described in terms of various specific embodiments, those skilled in the art will recognize that the invention can be practiced with modification within the spirit and scope of the claims.

What is claimed is:

1. A hook assembly comprising:
a shank portion;
a curved portion extending from said shank portion; and
a loop extending from said curved portion.

2. A hook assembly according to claim 1 wherein at least one of a hook, a weight, a spinner blade, and a trailer hook is coupled to said loop.

3. A hook assembly according to claim 1 wherein said curved portion has an inner edge and an outer trailing edge, said loop extending from said outer edge surface.

4. A hook assembly according to claim 1 wherein said loop is arcuate.

5. A hook assembly according to claim 1 wherein said loop is at least one of square shaped and triangular shaped.

6. A hook assembly according to claim 1 wherein said loop has a first end and a second end, at least one of said first and second ends is coupled to said curved portion and the other of said first and second ends is spaced from said curved portion.

7. A hook assembly according to claim 1 wherein said loop is formed integral to said curved portion.

8. A fishing lure system comprising:
a wire assembly; and
a hook assembly coupled to said wire assembly, said hook assembly includes a shank portion, a curved portion extending from said shank portion, a tail portion extending from said curved portion, and a loop extending from said curved portion.

9. A fishing lure system according to claim 8 wherein said loop is centrally located along an outer trailing edge of said curved portion.

10. A fishing lure system according to claim 8 wherein said loop is disposed along said curved portion between said shank portion and said tail portion.

11. A fishing lure system according to claim 8 wherein said loop is substantially planar to said curved portion.

12. A hook comprising:
an axis;
a shank portion substantially parallel to said axis;
a curved portion having a first end extending from said shank portion and curving away from said axis, said curved portion having a second end;
a tail portion extending from said second end of said curved portion; and
a loop extending from said curved portion.

13. A hook according to claim 12 comprising a spinner blade coupled to said loop.

14. A hook according to claim 12 wherein said curved portion has an inner edge and an outer trailing edge, said loop extending from said outer edge surface.

15. A hook according to claim 12 wherein said loop is arcuate.

16. A hook according to claim 12 wherein said loop has a first end and a second end, at least one of said first and second ends is coupled to said curved portion and the other of said first and second ends is spaced from said curved portion.

17. A hook according to claim 12 wherein said loop is formed integral to said curved portion.
